(19) United States
(12) Patent Application Publication
(10) Pub. No.: US 2021/0179813 A1
(43) Pub. Date: Jun. 17, 2021

(54) Silicate Polymeric Emulsion for High Barrier Coating

(71) Applicant: AGENCY FOR SCIENCE, TECHNOLOGY AND RESEARCH, Singapore (SG)

(72) Inventors: Xu Li, Singapore (SG); Siew Yee Wong, Singapore (SG)

(21) Appl. No.: 16/755,619

(22) PCT Filed: Oct. 25, 2018
(86) PCT No.: PCT/SG2018/050541

§ 371 Date: Apr. 13, 2020

(30) Foreign Application Priority Data
Oct. 25, 2017 (SG) 10201708775U

(51) Int. Cl. C08K 7/26; C09D 127/08; C08K 5/541; C08K 3/34

(52) U.S. Cl. CPC C08K 7/26; C08K 3/346; C08K 5/541; C09D 127/08

(57) ABSTRACT

The present disclosure relates to a barrier layer composition comprising at least one silicate, a polymer emulsion and at least two silane coupling agents. The present disclosure also provides a method of preparing the barrier layer composition as disclosed herein. Advantageously, the barrier layer composition of the present disclosure exhibits low permeability toward gas and water vapor molecules. As such, the present invention also relates to a laminated film comprising a substrate deposited with the barrier layer composition as disclosed herein.

### CROSS-REFERENCE TO RELATED APPLICATIONS

This application claims the benefit of priority of Singapore patent application No. 10201708775U, filed 25 Oct. 2017, the contents of it being hereby incorporated by reference in its entirety for all purposes.

### TECHNICAL FIELD

The present invention relates to a barrier layer composition for high barrier coating, a laminated film coated with a barrier layer comprising the same and preparation methods thereof.

### BACKGROUND ART

Plastic films such as polyethylene terephthalate (PET), polypropylene (PP) and polyethylene (PE) are commonly used as packaging materials due to their low cost, optical properties, strength and flexibility. While these materials are able to protect the wrapped product against physical damage, their ability to act as barriers against the permeation of oxygen and water vapor molecules is rather limited. These barrier properties of plastics are especially crucial in the food packaging industry. In particular, it is desirable for food packaging materials to be able to act as a barrier against oxidation and humidity in the environment in order to prolong the shelf life of the packaged foods.

To improve the barrier properties of the commercially available plastics, a barrier layer coating has been introduced on such plastics. These barrier layer compositions commonly consist of mixtures of polymers with inorganic or organic fillers to form certain geometries. Silicates, especially inorganic nanoclay fillers, have been shown to be particularly useful as their sheet-like structure provides a barrier against the permeation of gas molecules and water vapor. According to Nielsen's theory (1967), the presence of nanoclay fillers in the polymer composition increases the tortuosity of the diffusive path and prevents the permeation of a molecule, thus providing excellent barrier properties. In addition, inorganic silicates with a high aspect ratio, such as nanoclay have the advantages of being readily available, low cost, significant reinforcing effects and excellent processability.

However, while existing plastic films deposited with a barrier layer demonstrate improved resistance against water vapor molecules, many of these still demonstrate high oxygen transmission rates. In order to improve the barrier layer properties of current materials, several studies on the modification of silicate surfaces with organic compounds have been carried out. It has been found that the introduction of organic compounds to the silicate layers is able to improve the dispersion and compatibility between the silicate and polymers, which in turn, improves the barrier properties of the composition.

Organic-modified clay silicates have been combined with various polymers but with varying degrees of success. Firstly, organic modified silicate-polymer compositions which have been prepared to date are limited to specific polymers only. Due to the opposing polarities of organic modifiers, silicates, and polymers, preparation of these compositions have proved to be rather challenging. In addition, the improvement in barrier properties of these silicate-polymer combinations is rather limited. This may be due to the poor dispersion and orientation of the silicate sheets in the polymer emulsion.

An example of organic compounds which may be useful to improve the compatibility of the silicate and the polymer is organosilanes. However, the use of silanes in the preparation of barrier layer compositions may be challenging since the organophilic nature of silanes is incompatible with the aqueous solvent commonly used to suspend the silicate. In order to overcome this, surfactants are typically added to the silanes to form an emulsion prior to mixing with the aqueous silicate suspension.

One drawback to this approach is that the preparation of the silane emulsion is limited to a specific range of polarity, concentration and pH due to the addition of a surfactant. This makes it difficult to mix silanes into a single pot of aqueous silicate suspension in one step process. Moreover, the residual surfactants in the silane modified clay may have negative effects on the barrier properties, even though the surfactants are present only in a relatively low concentration.

Another method used for introducing the organophilic silane to the aqueous silicate suspension is the solvent exchange method. In this method, the aqueous silicate suspension is subjected to an organic solvent capable of dissolving the silane. The solvent may be polar organic solvents such as methanol, ethanol, propanol, butanol, or pentanol; or ketones such as propanone and 2-butanone. However, the solvent exchange method involves a complicated process comprising washing and filtration process for a few cycles. The use of large amounts of organic solvents in such methods not only makes the preparation of the barrier layer composition cumbersome, but also increases the cost of manufacturing.

Accordingly, there is a need to provide a barrier layer composition which not only exhibits improved barrier properties, but also maintains the flexibility and mechanical integrity of the substrate which it is deposited on. In order to achieve this, an efficient method for preparing such barrier layer compositions that overcomes the challenges discussed above is also desired.

### SUMMARY OF INVENTION

In one aspect of the present invention, there is provided a barrier layer composition comprising at least one silicate, a polymer emulsion, and at least two silane coupling agents, said silane coupling agents being different, and wherein each silane coupling agent is reactive with said silicate and/or said polymer emulsion.

Advantageously, the use of at least two silane coupling agents provides improved strength and barrier properties to the composition. The use of the two silane coupling agents allows extensive bonding to be formed between the silicate and the polymer, leading to dispersion of the silicate in the polymer emulsion. The disclosed method therefore allows about 1.0 wt % to about 20 wt % of the silicate to be included in the polymer emulsion, based on the total weight of the composition. The presence of the silicate advantageously improves the strength and barrier properties of the composition.

Advantageously, although a higher amount of the silicate is present in the composition, the optical properties of the barrier layer remain unaffected. In addition, the flexibility of the barrier layer formed from the disclosed composition is also unaffected despite the presence of the higher percentage of the silicate.

From a structural perspective, the extensive bonding allows intercalation of the polymer between the silicate sheets, allowing the formation of an ordered structure when a shearing force is applied to the composition. The formation of the ordered structure of the composition advantageously introduces high tortuosity to the material, and impedes the permeation of gas molecules when the composition is applied. The barrier properties of the composition are therefore improved with the use of the two silane coupling agents.

In another aspect of the present invention, there is provided a method of preparing a barrier layer composition comprising the steps of mixing at least two silane coupling agents with a silicate suspension; and adding said silicate suspension to a polymeric emulsion, wherein said two silane coupling agents are different from each other.

Advantageously, the method of preparing a barrier layer composition described herein leads to the formation of a uniform composition and overcomes the challenges of conventional synthesis methods. The mixing of the two organophilic silane coupling agents with the silicate suspension prior to its addition to the polymeric emulsion allows the formation of a stable mixture without the need for additives such as surfactants. This reduces the need for control of the reaction conditions which makes the preparation of the barrier layer composition less cumbersome. The barrier layer composition is substantially free of additives and surfactants.

The disclosed preparation methods advantageously avoid the need for employing polar organic solvents to first dissolve the organophilic silane coupling agents. Besides being more environmentally friendly, since organic solvents are not necessary, the preparation of the barrier layer composition requires less synthesis steps and may be carried out in a one-pot reaction. The barrier layer composition is also substantially free of organic solvents.

In yet another aspect of the invention, there is provided a laminated film comprising a substrate having at least one barrier layer deposited thereon, wherein said barrier layer comprises the composition as described herein, prepared by the methods described herein.

Advantageously, the laminated film deposited with the barrier layer composition disclosed herein substantially inhibits the permeation of gas and water vapor molecules. The application of the barrier layer composition on a substrate allows the alignment of the silicate sheets of the substrates. The presence of the ordered composition on the substrate presents a tortuous path for the permeation of gas and water molecules. Indeed a polyethylene terephthalate film deposited with the barrier layer composition disclosed herein exhibits a decreased oxygen transmission rate of only 9.03 cc/(m².day) at a thickness of only 2.5-3.5 μm at 80% room humidity. This is a marked improvement over available polyethylene terephthalate/polyolefin films which typically exhibit an oxygen transmission rate of higher than 150 cc/(m².day).

### BRIEF DESCRIPTION OF THE DRAWINGS

The accompanying drawings illustrate a disclosed embodiment and serves to explain the principles of the disclosed embodiment. It is to be understood that the drawings are for purposes of illustration only and not as a definition of the limits of the invention

FIG. 1 is a TEM image of a cross section of the barrier layer composition, formed from montmorillonite clay and polyvinylidine chloride and deposited on a polyethylene terephthalate substrate. The arrow shows the orientation of the silicate sheets along the plastic substrate.

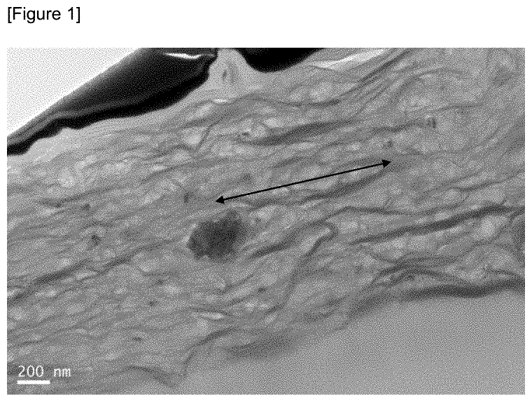

### DESCRIPTION OF THE EMBODIMENTS

In a first aspect, the present invention relates to a barrier layer composition comprising at least one silicate, a polymer emulsion, and at least two silane coupling agents, said silane coupling agents being different, and wherein each silane coupling agent is reactive with said silicate and/or said polymer emulsion.

The silicate may be any silicate with a plate-like structure which can be exfoliated in a suitable solvent to form a suspension of silicate sheets. In one embodiment, the silicate may be dispersed in an aqueous solvent. The dispersion of the silicate in an aqueous solvent may form isolated sheets or small domains consisting of a few sheets in the suspension. The dispersion of the silicate in a solvent may allow the silicate to undergo hydration. The silicate may be hydrated to expose functional groups on the silicate for reaction with the silane coupling agents

The silicate may be any silicate which possesses a high aspect ratio. The silicate may be natural clay or synthetic clay. The silicate may be selected from the group consisting of montmorillonite, beidellite, nontronite, hectorite, bentonite, laponite, kaolinite, saponite, vermiculite and mixtures thereof. In one embodiment, the silicate is montmorillonite.

The amount of silicate in the barrier layer composition may be in the range of about 0.1 to about 20%, about 0.1 to about 15%, about 0.1 to about 12.5%, about 0.1 to about 10%, about 0.1 to about 7.5%, about 0.1 to about 5%, about 0.1 to about 2.5%, about 0.1 to about 1.5%, about 0.1 to about 1%, more preferably about 0.5 to about 1%, by weight of the composition. In one embodiment, the amount of silicate is about 0.9%, by weight of the composition.

The polymer may be any hydrophobic polymer suspended in an aqueous solvent. The polymer may which contain groups capable of reacting with the silane coupling agent. The polymer may comprise at least one functional group selected from the group consisting of alkanes, alkenes, alkynes, hydroxyls, halogens, ketones and ethers. The polymer may be The polymer may be selected from the group consisting of poly(methyl methacrylate) (PMMA), poly(2-Chloroethyl vinyl ether) (PCVE), poly(hydroxyethylmethacrylate) (PHEM), polyvinylidene chloride (PVDC) and mixtures thereof. In one embodiment, the polymer emulsion is polyvinylidene chloride (PVDC) emulsion.

The amount of the polymer in the barrier layer composition may be in the range of about 0.5 to about 40 wt %, about 0.5 to about 35 wt %, about 0.5 to about 30 wt %, about 0.5 to about 25 wt %, about 0.5 to about 20wt %, about 0.5 to about 15 wt %, about 0.5 to about 10 wt %, about 1.0 to about 10 wt %, about 1.5 to about 15 wt % about 2.0 to about 10 wt %, about 2.5 to about 10 wt %, about 3.0 to about 10 wt %, about 3.5 to about 10 wt %, about 4.0 to about 10 wt %, more preferably about 5.0 to about 10 wt %. In one embodiment, the amount of polymer is about 8.5 wt %.

The weight ratio of the silicate to the polymer in the composition may be in the range of about 1:1 to about 1:30, about 1:1 to about 1:25, about 1:1 to about 1:20 about 1:2 to about 1:20, about 1:5 to about 1:20, about 1:10 to about 1:20, about 1:10 to about 1:15, about 1:10 to about 1:12, more preferably about 1:10 to about 1:12. In one embodiment, the ratio of the silicate to the polymer is about 1:10.

The silicate may be bonded to the polymer by a silane coupling agent. The silane coupling agent may be any silane substituted with functional groups capable of reacting with the silicate and/or the polymer.

The silane coupling agents may be provided in a total amount of from about 0.01 to about 1%, from about 0.01 to about 0.9%, from about 0.01 to about 0.8%, from about 0.01 to about 0.7%, from about 0.01 to about 0.6%, from about 0.01 to about 0.5%, from about 0.01 to about 0.4%, from about 0.01 to about 0.3%, from about 0.01 to about 0.2%, more preferably from about 0.01 to about 0.1%, by weight of the composition. In one embodiment, the silane coupling agents are provided in a total amount of about 0.08%, by weight of the composition.

The silane coupling agents may comprise a first and a second silane coupling agent, wherein said first silane coupling agent and second coupling agent may be selected to contain distinct functional groups. The functional groups may be reactive with at least one reactive functional group of the polymer emulsion. The functional groups of the silane coupling agents may be independently selected from the group consisting of alkenyl, alkynyl, alkoxy, hydroxyl, thiol, sulfide, nitrile, ether, cyclic ethers, carboxylic acids, epoxide, amine and halide groups. The first silane coupling agent may preferably comprise alkoxy and amine groups, while the second silane coupling agent may preferably comprise alkoxy and epoxide functional groups. The first silane coupling agent may preferably be an aminosilane while the second silane coupling agent may preferably be an epoxysilane.

Advantageously, the use of at least two silane coupling agents, which comprise at least two distinct functional groups allows bonds to be formed between the silicate and the polymer to be chemically linked. In a particular embodiment, the alkoxy functional groups of silane coupling agents bind to the silicate, while the more reactive amino and epoxide functional groups react with the polymer emulsion to bind the silicate and the polymer. This allows better adhesion of the silicate to the polymer and improves the dispersion of an extended silicate-polymer network to be formed, which in turn lends strength and high tortuousity to the barrier layer composition.

The first silane coupling agent and a second silane coupling agent may be provided at a weight concentration ratio of about 1:1 to 1:10, about 1:1 to 1:9, about 1:1 to 1:8, about 1:1 to 1:7, about 1:1 to 1:6, about 1:1 to 1:5, about 1:1 to 1:4, about 1:1 to 1:3, more preferably about 1:1 to 1:2. In one embodiment, the first silane coupling agent is (3-aminopropyl)trimethoxysilane, while the second silane coupling agent is (3-glycidoxypropyl)trimethoxysilane, and are provided at a weight concentration ratio of 5:9.

Advantageously, a barrier layer composition comprising (3-aminopropyl)trimethoxysilane and 3-glycidoxypropyl)trimethoxysilane, provided at a concentration ratio of 5:9 provides a material with the lowest permeability to gas and water vapor molecules.

The barrier layer composition may comprise solids suspended in an aqueous solution. The barrier layer composition may have a total solid concentration of about 2 to about 30 wt %, about 5 to about 30 wt %, about 5 to about 25 wt %, about 5 to about 20 wt %, about 5 wt % to about 15 wt %, about 5 wt % to about 10 wt %. In one embodiment, the total solid concentration is 9.8 wt %.

The aqueous solution used to suspend the solids may be water or deionized water. In one embodiment, the aqueous solution is deionized water. The aqueous content of the barrier layer composition may be about 70 to about 98 wt %, about 75 to about 98 wt %, about 80 to about 98 wt %, about 85 to about 98 wt %, about 85% to about 95 wt %, about 88 to about 95 wt %, more preferably about 88 to about 92 wt % . In one embodiment, the aqueous solution is provided at 90.2 wt %.

In a second aspect, the present invention is also related to a method of preparing a barrier layer composition comprising the steps of mixing at least two silane coupling agents with a silicate suspension; and adding said silicate suspension to a polymeric emulsion, wherein said two silane coupling agents are different from each other. The preparation of a barrier layer composition may comprise introducing a first silane coupling agent and a second silane coupling agent to said silicate suspension, wherein said first and second silane coupling agents are independently selected to comprise distinct reactive functional groups.

The preparation of the barrier layer composition is carried out in aqueous solvents and does not require the use of organic solvents. In one embodiment, the preparation of the barrier layer composition is carried out using water only. The prepared barrier layer composition is substantially free of organic solvents.

The barrier layer composition may be obtained by adding the first and second coupling agents sequentially to a suspension comprising said silicate, and wherein the suspension is subsequently added to said polymeric emulsion. In one embodiment, the barrier layer composition is prepared by slow addition of a first silane coupling agent to a silicate suspension, followed by a second slow addition of a second coupling agent to form the silane-silicate suspension. The addition of the silane coupling agents to an aqueous silicate suspension may be carried out under high speed mechanical stirring for a fixed time duration.

The mixing of the silane coupling agents with an aqueous silicate suspension may be carried out by homogenizing using physical stirring means. The stirring may be carried out at a speed of about 12000 to about 17000 rpm, about 13000 to about 17000 rpm, about 14000 to about 17000 rpm, about 15000 to about 17000 rpm, about 16000 to about 17000 rpm, about 12000 to about 16000 rpm, about 12000 to about 15000 rpm, about 12000 to about 14000 rpm, about 12000 to about 13000 rpm, more preferably at about 15,000 rpm. The mixing may be carried out for about 15 minutes, 10 minutes or more preferably 5 minutes.

Using the presently disclosed methods, additives such as surfactants are not required for the preparation of the barrier layer composition. In one embodiment, the preparation of the barrier layer composition is carried out without surfactants. As such, the prepared barrier layer composition is also substantially free of surfactants.

Advantageously, the slow addition of the first silane coupling agent, followed by the second coupling agent under high-speed stirring conditions allows homogenization of the organophilic silane coupling agents in the aqueous suspension of the silicate. In particular, the disclosed method does not require prior dissolution of the silicate in a water-miscible organic solvent. Conventional solvent exchange methods are therefore not required, and this enables the preparation of the barrier layer composition to be carried out in a one-pot reaction.

Further, the presently disclosed method advantageously also overcomes the need for additives such as surfactants to enable the organophilic silane coupling agents to be homogenized with the aqueous suspension of the silicate. Since the presently disclosed method does not require the use of these additives, the preparation of the barrier layer composition is less cumbersome and requires less control over reaction conditions. Therefore, the presently disclosed method more amenable to reaction scale-up for industrial purposes.

Advantageously, since the addition of a surfactant is not necessary, a more closely packed and strongly bonded barrier layer composition is formed. In the absence of the surfactant, the silicate and polymer may be bonded directly through the silane coupling agents without interference from the surfactant molecules. This enables a more strongly bonded barrier layer composition to be formed, which contributes the improved tortuousity of the barrier layer composition. As such, a barrier layer composition with low gas permeability and a lower oxygen transmission rate of 9.03 cc/(m².day) is obtained using the present methods.

The presently disclosed method may also comprise sequential addition of the first silane coupling agent to a silicate suspension, followed by said second silane coupling agent. In one embodiment, after the preparation of an aqueous suspension of the silicates, the silane coupling agents may be added sequentially into the suspension to form the silane-silicate suspension. The first silane coupling agent is added to the silicate suspension, followed by said second silane coupling agent. In one embodiment, the aminosilane coupling agent is first added to the silicate suspension, followed by the epoxysilane coupling agent. The barrier layer composition is therefore obtained by adding the first and second coupling agents sequentially to a suspension comprising said silicate, and wherein the suspension is subsequently added to said polymeric emulsion

The sequential addition advantageously prevents any cross reaction between the two silane coupling agents from occurring. The addition of the first aminosilane coupling agent allows its alkoxy groups to first react with the silicate, leaving the amino groups to interact with the polymer. Similarly, the subsequent addition of the epoxysilane coupling agent allows the alkoxy functional groups to first react with the silicate, while the epoxide functional group is free to react with the polymer. Sequential addition of the silane coupling agents prevents the silane coupling agents from reacting with each other.

The second step in the preparation of the barrier layer composition employs the addition of a silane-silicate suspension to a polymer emulsion. Prior to the addition, the polymer emulsion may be prepared by stirring a liquid polymer in an aqueous solution for about 15 minutes, 10 minutes, 5 minutes or more preferably 3 minutes. This is quickly followed by addition of the silane-silicate suspension may be carried out slowly and left to stir for an initial period of 15 minutes, 10 minutes or more preferably, 5 minutes.

The addition of the silane-silicate suspension to the polymeric emulsion may be carried out by homogenizing the composition using physical stirring means. High speed stirring may be applied to the mixture. The mixture can be stirred at a speed of about 12,000 to about 17,000 rpm, about 13,000 to about 17,000 rpm, about 14,000 to about 17,000 rpm, about 15,000 to about 17,000 rpm, about 16,000 to about 17,000 rpm, about 12,000 to about 16,000 rpm, about 12,000 to about 15,000 rpm, about 12,000 to about 14,000 rpm, about 12,000 to about 13,000 rpm or more preferably at about 15,000 rpm. The high-speed stirring may be carried out for a period of 30 minutes, 25 minutes, 20 minutes, 10 minutes, 5 minutes or more preferably 15 minutes.

Advantageously, stirring the mixture at high speeds enables good dispersion of the silane-silicate suspension in the polymer emulsion. This allows the silane-silicate suspension to have better contact with the polymer and may consequently enable the silane coupling agents to react with the polymer. As a result, the silicate is able to achieve better bonding with the polymer, leading to the formation of an ordered structure which exhibits good gas barrier, strength and flexibility.

In a particular embodiment, the preparation of the barrier layer composition was carried out by first suspending the silicate in water by stirring for 6 hours, followed by ultrasonication in a water bath for 30 minutes. This was followed by slow and sequential addition of a first aminosilane coupling agent, and a second epoxysilane coupling agent. The formation of the silane-silicate suspension was carried out with stirring at 15,000 rpm for 15 minutes. The silane-silicate suspension was added slowly to a prepared polymer emulsion. Homogenization of the mixture was carried out by rapid stirring at 15,000 rpm for 15 minutes to obtain the barrier layer composition disclosed herein. The final product is a suspension of the silicate and the polymer.

Advantageously, the presently disclosed method may also be used with polymers other than those listed above. Since the presently disclosed method does not involve the use of additives and organic solvents, there are no specific limitations on the solubility or polarity of the polymers which may be used. As such, the disclosed methods may also be used with both water soluble and non-water soluble polymers.

In a third aspect of this invention, there is provided a laminated film comprising a substrate deposited with at least one layer of the barrier layer composition described herein and provided using the methods described herein. The deposition of the barrier layer composition on a substrate forms a laminated bilayer film.

The substrate used in the laminated film may be any polymeric substrate or plastic film which may be used as packaging material. The substrate may be a biaxially or uniaxially oriented polymer which at least partially allows light to pass through. The substrate may be polyethylene terephthalate, high density polyethylene, low density polyethylene or polyvinyl chloride. In one embodiment, the substrate is polyethylene terephthalate.

The deposition of the barrier layer composition on the substrate forms a bilayer composite material. The deposition may be carried out by coating the barrier layer composition via blade coating using a film applicator. The application may be carried out using a shearing force. Advantageously, the shearing force aligns the silicate sheets in the barrier layer composition with the surface of the plastic substrate. After the initial application, the laminated bilayer film may be dried to remove the aqueous solvent of the barrier layer composition. The drying may be carried out by air flash at room temperature, followed by vacuum drying at about 90° C., about 80° C., about 70° C., about 60° C., about 50° C., more preferably at 60° C. The temperature of the drying step may be selected according to the substrate used in the laminated film.

Advantageously, the application of heat during the drying of the barrier layer composition may assist the reaction of the silane coupling agents with the polymer emulsion. The reaction of the silane coupling agents with the functional groups on the polymer improves the interaction between the silicate sheets and the polymer. In the barrier layer, the polymer is in continuous phase with the silicate sheets distributed in polymer matrix. This forms a hierarchical structure, with the polymer matrix intercalated between the silicate sheets. This improves the tortuosity of the barrier layer composition and results in a laminated film with improved barrier properties as well.

The final concentration of silicate-polymer composition which is applied onto the substrate may be in the range of about 1 to about 50 wt %, about 10 to about 50 wt %, about 20 to about 50 wt %, about 30 to about 50 wt %, about 40 to about 50 wt %, about 10 to about 20 wt %, about 10 to about 30 wt %, about 10 to about 40 wt %, about 1 to about 10 wt %, about 1 to about 9 wt %, about 1 to about 8 wt %, about 1 to about 7 wt %, about 1 to about 6 wt %, about 1 to about 5 wt %, about 1 to about 4 wt %, about 1 to about 3 wt %, about 1 to about 2 wt %, about 2 to about 10 wt %, about 3 to about 10 wt %, about 4 to about 10 wt %, about 5 to about 10 wt %, about 6 to about 10 wt %, about 7 to about 10 wt %, about 8 to about 10 wt %, about 9 to about 10 wt %, about 3 to about 8 wt %, more preferably at about 5 to about 7 wt %. In one embodiment, the concentration of the silicate-polymer composition is about 7%, by weight of the composition. The concentration of barrier layer may be calculated by measuring the weight change of a part of the resulting silicate (when in suspension) before and after complete drying.

The gelatinous barrier layer composition may be applied at an initial thickness of about 1 to about 55 μm, about 5 to about 55 μm, about 10 to about 55 μm, about 15 to about 55 μm, about 20 to about 55 μm, about 25 to about 55 μm, about 30 to about 55 μm, about 35 to about 55 μm, about 40 to about 55 μm, about 45 to about 55 μm, about 5 to about 45 μm, about 5 to about 40 μm, about 5 to about 35 μm, about 5 to about 30 μm, about 5 to about 25 μm, about 5 to about 20 μm, about 5 to about 15 μm, about 5 to about 10 μm or more preferably in the range of about 5 to about 50 μm.

After drying, the barrier layer composition may have a thickness of 0.10 to about 4.5 μm, about 0.15 to about 4.5 μm, about 0.20 to about 4.5 μm, about 0.25 to about 4.5 μm, 0.30 to about 4.5 μm, 0.35 to about 4.5 μm, 0.40 to about 4.5 μm, 0.45 to about 4.5 μm, 0.50 to about 4.5 μm, about 0.10 to about 4.0 μm, about 0.10 to about 3.5 μm, about 0.10 to about 3.0 μm, about 0.10 to about 2.5 μm, about 0.10 to about 2.0 μm, about 0.10 to about 1.0 μm, about 0.10 to about 0.25 μm, about 0.25 to about 4.0 μm, about 0.25 to about 3.0 μm, about 0.25 to about 2.5 μm, about 0.25 to about 2.0 μm, about 2.0 to about 4.5 μm, about 2.5 to about 4.5 μm, about 3.0 to about 4.5 μm, about 3.5 to about 4.5 μm, about 2.0 to about 3.5 μm, about 2.5 to about 3.5 μm, more preferably about 0.25 to about 3.5 μm. In a particular embodiment, the barrier layer composition has a thickness of about 2.5-3.5 μm.

The laminated bilayer film may also be combined with another substrate deposited with an adhesive to form a laminated trilayer film. The presence of the adhesive may improve the adhesion between the two films. During application of the adhesive layer, heating may be carried out. The heating step may be a laminating step. The heating may be carried out at in the range of 90 to 150° C., 100 to 150° C. or more preferably in the range of 100 to 140° C. In one embodiment, when the substrate is polyethylene terephthalate, heating is carried out at about 130° C. Optionally, pressure may be applied during the lamination process to better align the silicate sheets with the substrate.

In a particular embodiment, the barrier layer composition was coated on a polyethylene terephthalate film using a film applicator with a wire bar coater with gap of 3 μm. The laminated bilayer film was cured at 120° C. for 3 hours and aged further at 80° C. for 48 hours.

Advantageously, the laminated film comprising a substrate deposited with the silicate-polymer composition disclosed herein exhibits improved barrier properties. The application of heat and shearing forces during the preparation of the laminated film aligns the silicate sheets against the substrate while the presence of the intercalated polymer between the silicate sheets provides a high-tortuosity material, which presents a barrier against gas molecules and water vapor molecules. This is evident from the significant decrease in the oxygen transmission rate of films laminated with the disclosed barrier layer composition. At a thickness of only 2.5-3.5 μm, the laminated film shows a low oxygen transmission rate of only 9.03 cc/m².day, even at high humidity of 80%.

### EXAMPLES

Non-limiting examples of the invention will be further described in greater detail by reference to specific Examples, which should not be construed as in any way limiting the scope of the invention.

### Example 1

### Preparation of Silane-Silicate Suspension

2.0 g of pristine clay (montmorillonite) obtained from Nanocor Inc. of Arlington Heights of Illinois of the United States of America was mixed with 100 ml deionised water and stirred for 6 hours, followed by ultrasonication in a water-bath for 30 minutes to prepare a silicate suspension. After that, 0.1 g of (3-aminopropyl)trimethoxysilane (97%, Aldrich) was first mixed into the silicate suspension, followed by 0.15 g of (3-glycidoxypropyl)trimethoxysilane 98%, Aldrich) under high speed of homogenizing process at 15,000 rpm by using an IKA T18 Basic Ultra Turrax for 15 minutes to obtain silanes-silicate suspension.

### Example 2

### Preparation of Silicate/PVDC Emulsion

6.13 g of PVDC was added into 30.28 ml of deionised water and the PVDC solution was mechanically stirred for 5 minutes. 33.6 g of the silanes-silicate suspension obtained from Example 1 was then added dropwise into the PDVC solution while stirring and left to stir for 5 minutes to obtain a mixed suspension. The mixed suspension was then homogenized at 15,000 rpm for 15 minutes by using an IKA T18 Basic Ultra Turrax to prepare silicate/PVDC emulsion.

### Example 3

### Preparation of Silicate/PVDC/PET Film

The silicate/PVDC emulsion obtained from Example 2 was coated onto a PET film by using a film applicator with a wire bar coater with gap of 3 μm to obtain a layer. The layer coated on the PET film was then dried at 120° C. for 3 hrs and aged at 80° C. for 48 hrs.

### Example 4

### Test Method—Oxygen Transmission Rate

Oxygen permeability of the silicate/PVDC/PET film was measured by using Mocon oxygen permeability OX-TRAN Model 2/21 according to ASTM D3985. Each film was placed on a stainless steel mask with an open testing area of 5 cm². Oxygen permeability measurements were conducted at 23° C. (1 atm) and at 80% relative humidity by placing layer surface of the films to the oxygen rich side.

The transmission rate of oxygen for PET films without silicate/PVDC layer, measured at 23° C. at 0% RH, is 130 cc/(m2-day) whereas PET films with silicate/PVDC layer, measured at 23° C. at 80% RH, show a significant decrease to 9.03 cc/(m2-day). The thickness of the layer is controlled in a range of about 2.5-3.5 μm, which is depends on the final total solid content concentration. Meanwhile, the thickness of the PET film is about 12 μm. The oxygen transmission rates of the silicate/PVDC/PET films were significantly reduced in comparison to that of pure PET film, even in high RH of 80%.

### Example 5

### Test Method—Cross-Section TEM Image of Silicate/PVDC Layer

TEM observation of thin sections of the silicate/PVDC/PET film was performed with a JEOL 2100 TEM under an acceleration voltage of 200 kV. The thin sections were cut from the silicate/PVDC/PET film embedded in epoxy resin under cryogenic conditions using a Leica ultramicrotome equipped with a diamond knife.

### INDUSTRIAL APPLICABILITY

The disclosed barrier layer composition may be used for the development of food packaging materials. The disclosed barrier layer composition may be deposited on any commercially available plastic materials used for packaging. The deposition of the barrier layer composition on the plastic materials imparts enhanced barrier properties, preventing the permeation of oxygen and humidity, without compromising the the strength, flexibility and transparency of the plastic film.

The laminated plastic films may be used as packaging materials in the food packaging industry, medicine packaging industry, personal care packaging industry and electronic packaging industry. Films deposited with the barrier layer composition may be particularly useful in the food packaging industry, where it is crucial to protect wrapped products against oxidation and deterioration caused by exposure to atmospheric oxygen and humidity. The improved barrier properties of the laminated films may assist to prolong the shelf life of the packaged foods and food products.

The presently disclosed method of preparing a barrier layer composition involves a two-step procedure, which may be carried out in as a single pot reaction. The lack of organic solvents and additives in the disclosed method simplifies the reaction procedure and reduces the need for strict control of reaction conditions. The simplified one-pot reaction procedure, makes the presently disclosed method more amenable toward industrial scale-up and manufacture.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

It should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

1. A barrier layer composition comprising:
a) at least one silicate;
b) a polymer emulsion comprising a hydrophobic polymer suspended in water; and
c) at least two silane coupling agents, said silane coupling agents being different, and wherein each silane coupling agent is reactive with said silicate and/or said polymer emulsion; and
wherein a weight ratio of the silicate to the polymer is 1:5 to 1:20.

2. The barrier layer composition according to claim 1, wherein the composition comprises a first silane coupling agent and a second silane coupling agent, wherein said first and second silane coupling agents are independently selected to contain distinct functional groups.

3. The barrier layer composition according to claim 2, wherein the functional groups are independently selected from the group consisting of alkenyl, alkynyl, alkoxy, hydroxyl, thiol, sulfide, nitrile, carboxylic acid, epoxide, amine, and halide groups.

4. The barrier layer composition according to claim 2, wherein the first silane coupling agent comprises alkoxy and amine functional groups; and wherein the second silane coupling agent comprises alkoxy and epoxide functional groups.

5. The barrier layer composition according to claim 4, wherein a weight concentration ratio of the first silane coupling agent to the second silane coupling agent is in a range of 1:1 to 1:10.

6. The barrier layer composition according to claim 5, wherein the silane coupling agents are provided in a total amount of from about 0.01% to about 1%, by weight of the composition.

7. The barrier layer composition according to claim 2, wherein the composition is obtained by adding the first and second coupling agents sequentially to a suspension comprising said silicate, and wherein the suspension is subsequently added to said polymeric emulsion.

8. The barrier layer composition according to claim 7, wherein the composition is homogenized by physical stirring means.

9. The barrier layer composition according to claim 1, wherein the polymer is present in a range of about 0.5% to about 40% by weight of the composition.

10. The barrier layer composition according to claim 1, wherein the silicate is present in a range of about 0.1% to about 20% by weight of the composition.

11. A method of preparing a barrier layer composition, the method comprising the steps of:
a) mixing at least two silane coupling agents with a silicate suspension; and
b) adding said silicate suspension to a polymeric emulsion comprising a hydrophobic polymer suspended in water;
wherein said two silane coupling agents are different from each other; and
wherein a weight ratio of the silicate to the polymer is 1:5 to 1:20.

12. The method of preparing a barrier layer composition according to claim 11, wherein the mixing step comprises introducing a first silane coupling agent and a second silane coupling agent to said silicate suspension, wherein said first and second silane coupling agents are independently selected to comprise distinct reactive functional groups.

13. The method according to claim 12, wherein the functional groups are selected from the group consisting of alkenyl, alkynyl, alkoxyhydroxyl, thiol, sulfide, alkoxy, nitrile, carboxylic acid, epoxide, amine, and halide groups.

14. The method according to claim 13, wherein the first silane coupling agent comprises alkoxy and amino functional groups; and the second silane coupling agent comprises alkoxy and epoxide functional groups.

15. The method according to claim 13, wherein the mixing step comprises providing the first coupling agent and the second coupling agent in a weight concentration ratio of from about 1:1 to about 1:10.

16. The method according to claim 12, wherein the adding step comprises a sequential addition of the first silane coupling agent to said silicate suspension, followed by said second silane coupling agent.

17. The method according to claim 11, wherein the adding step further comprises homogenizing said polymeric emulsion by physical stirring means.

18. A laminated film comprising a substrate having at least one barrier layer deposited thereon, wherein said barrier layer comprises the composition according to claim 1.

19. A laminated film comprising a substrate having at least one barrier layer deposited thereon, wherein said barrier layer is prepared by the method according to claim 11.
